(19) United States
(12) Patent Application Publication
(10) Pub. No.: US 2008/0201258 A1
(43) Pub. Date: Aug. 21, 2008

(54) Process for Managing Domain Name Registrations

(76) Inventor: Mark D'AMBROSIO, Scottsdale, AZ (US)

Correspondence Address: PATTERSON & SHERIDAN, L.L.P., 3040 POST OAK BOULEVARD, SUITE 1500, HOUSTON, TX, 77056, US

(21) Appl. No.: 11/832,606

(22) Filed: Aug. 1, 2007

Related U.S. Application Data
(60) Provisional application No. 60/890,615, filed on Feb. 19, 2007.

(51) Int. Cl. G06Q 10/00; G06Q 40/00

(52) U.S. Cl. 705/39; 705/1

(57) ABSTRACT

Domain names are registered with a domain name registration service for an indefinite period in exchange for a lump sum payment from the domain name registrant. The domain name registration service registers the domain name in the name of the domain name registrant and the domain name registration is kept active so long as the domain name registrant keeps the lump sum payment with the domain name registration service. If the user cancels the indefinite-period domain name registration, the lump sum payment is returned to the user minus any applicable penalties for early cancellation.

### CROSS-REFERENCE TO RELATED APPLICATIONS

This application claims the benefit of U.S. Provisional Patent Application Ser. No. 60/890,615, filed Feb. 19, 2007, which is herein incorporated by reference.

### BACKGROUND OF THE INVENTION

1. Field of the Invention

Embodiments of the present invention relate generally to domain name registrations and, more particularly, to a process and a computer system for registering domain names for an indefinite period.

2. Description of the Related Art

The Internet comprises a large number of interconnected computers and computer networks. The interconnected computers include web servers that provide information and services and client or user computers that access information and services of the web servers. The web servers are programmed to communicate with the client computers and other web servers using the TCP/IP protocol. The client computers are programmed to execute web browser programs and access the web pages managed by the web servers by specifying a uniform resource locator (URL) for the web server into the browser.

Web pages are typically defined using HyperText Markup Language (“HTML”). HTML provides a standard set of tags that define how a web page is to be displayed. When a user accesses a web page, the browser sends a request to the web server to transfer to the client computer an HTML document that defines the web page. When the requested HTML document is received by the client computer, the client computer displays the web page as defined by the HTML document.

The actual Internet address of the web server consists of a string of numbers, such as 66.230.200.100, and is very difficult to remember. Therefore, a domain name system has been developed to associate easy-to-remember domain names, such as www.uspto.gov, to numerical Internet addresses. A domain name is associated with a numerical Internet address through a process known as domain name registration, and this process is governed by Internet Corporation for Assigned Names and Numbers (“ICANN”). A company that manages the domain name registration process governed by ICANN is known as a domain name registrar.

The process for registering a domain name requires a user to access the web site of an ICANN-approved registrar and specify: (1) a domain name that the user desires to register, and (2) a fixed period for registration, typically 1 year. The registrar then determines if the desired domain name is available. If the desired domain name has not been registered, the registrar advises the user, and the user can proceed with the registration of the domain name for the specified fixed period by submitting payment for the domain name registration. The user also provides certain personal information to complete the registration. That information includes the customer's mailing address, e-mail addresses and phone numbers, and mailing addresses of administrative and technical contacts for the domain name.

Thereafter, updates are pushed out to the domain name servers distributed around the Internet so that the numerical Internet address of the user's host web server can be associated with the newly registered domain name. Also, the registrar transmits certain information to ICANN, as a result of which the user will be identified as the “registrant” of the domain name. The registrar also pays ICANN for the domain name registration for the user-specified fixed period. In response, ICANN adds the domain name, the registrant's name, the expiration date of the domain name registration and identification of the registrar to the part of the WHOIS database kept by ICANN, and confirms the domain name registration. The registration process is concluded by the registrar by confirming the registration to the user.

### SUMMARY OF THE INVENTION

Embodiments of the present invention provide a process and a computer system for managing domain name registrations. According to embodiments of the present invention, the user requests a domain name registration service to register a domain name for an indefinite period in exchange for a lump sum payment made to the domain name registration service. The lump sum payment is payable to the user when the user cancels the domain name registration.

According to one aspect of the present invention, the domain name registration service is a domain name registrar. According to this example, in response to the user's request to register a domain name for an indefinite period and the lump sum payment, the domain name registrar registers the domain name for a fixed period in the user's name and, so long as the user keeps the lump sum payment with the domain name registrar, the domain name registrar automatically renews the domain name registration for a fixed period each time the domain name registration comes up for renewal. If the user cancels the indefinite-period domain name registration, the lump sum payment is returned to the user minus any applicable penalties for early cancellation, and the domain name registration is allowed to expire at the end of the current term.

According to another aspect of the present invention, the domain name registration service is ICANN or any other organization that has been entrusted with the task of managing the assignment of domain names and IP addresses. According to this example, in response to the user's request to register a domain name for an indefinite period and the lump sum payment, the domain name registration service registers the domain name in the user's name and keeps the status of the domain name registration active so long as the user keeps the lump sum payment with the domain name registration service. If the user cancels the indefinite-period domain name registration, the lump sum payment is returned to the user minus any applicable penalties for early cancellation, and the domain name registration is cancelled.

A process for managing domain name registrations according to an embodiment of the present invention includes receiving a request to register a domain name for an indefinite period, registering the domain name for a specified period, and prior to expiration of the domain name registration, renewing the domain name registration. The process may further include receiving payment data along with the request, and initiating an electronic funds transfer into an investment account using the payment data. The funds transferred into the investment account are payable to the registrant minus any applicable penalties for early cancellation.

A process for managing domain name registrations according to another embodiment of the present invention includes receiving a request to renew a domain name registration for an indefinite period, renewing the domain name registration for a first specified period, and prior to expiration of the domain name registration, renewing the domain name registration for a second specified period. The process may further include receiving payment data along with the request, and initiating an electronic funds transfer into an investment account using the payment data. The funds transferred into the investment account are payable to the registrant minus any applicable penalties for early cancellation.

A computer system for managing domain name registrations according to an embodiment of the present invention includes a domain name database storing multiple datasets, each dataset identifying a domain name, a registrant, an expiration date for the domain name registration, and amount of money that is payable to the registrant, and a processor programmed to: (i) submit domain name renewal registration data to ICAAN prior to the expiration date for the domain name registration, and (ii) initiate a payment to the registrant of the amount of money that is payable to the registrant in response to a request to cancel the domain name registration.

Embodiments of the present invention also provide a process for renewing a domain name registration continuously for an indefinite period using electronic funds of a domain name registrant that have been deposited into an investment account. This process includes the steps of investing the electronic funds in the investment account, and renewing the domain name registration for a specified period on a periodic basis using the electronic funds in the investment account. This process may further include the step of depositing additional electronic funds of the domain name registrant into the investment account after the step of renewing has been carried out at least one time. The additional electronic funds are used to cover for any cost increase imposed by ICANN for registering domain names.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a networked computer environment in which the present invention may be practiced.

FIG. 2A illustrates the process for managing domain name registrations according to a first embodiment of the present invention.

FIG. 2B illustrates the process for managing domain name registrations according to a second embodiment of the present invention.

FIG. 3 illustrates the process carried out by a domain trust registrar for managing the registration or renewal of a domain name with ICANN.

FIG. 4 is a flow diagram that illustrates the steps that are carried out by a domain trust registrar in the management of domain name registrations.

FIG. 5 is a flow diagram that illustrates the steps that are carried out by a third party registrar and a domain trust registrar to process a domain name registration for an indefinite period.

FIG. 6 is a flow diagram that illustrates the steps that are carried out by a third party registrar and a domain trust registrar to process a domain name renewal for an indefinite period.

FIG. 7 is a flow diagram that illustrates the steps that are carried out by a domain trust registrar when automatically renewing a domain name registration.

FIG. 8A illustrates a process for managing domain name registrations according to a third embodiment of the present invention.

FIG. 8B illustrates a process for managing domain name registrations according to a fourth embodiment of the present invention.

For clarity, identical reference numerals have been used, where applicable, to designate identical elements that are common between figures. It is contemplated that features of one embodiment may be incorporated in other embodiments without further recitation.

### DETAILED DESCRIPTION

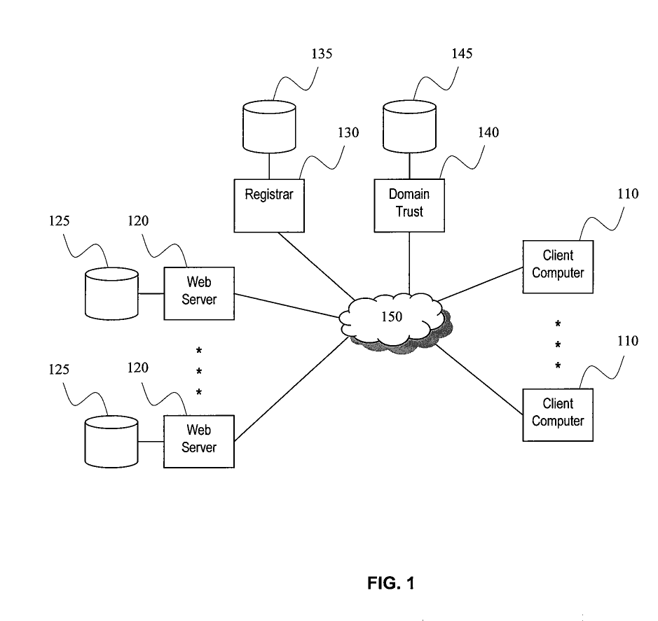

FIG. 1 illustrates a networked computer environment in which the present invention may be practiced. As shown, the networked computer environment includes a plurality of client computers 110 (only two of which are shown), a plurality of web servers 120 with associated content storage units 125 (only two of which are shown), a web server 130 of an ICANN-approved registrar with an associated content storage unit 135, and a web server 140 of another ICANN-approved registrar (hereinafter referred to as a “domain trust registrar”) with an associated content storage unit 145. The client computers 110, the web server computers 120, the web server 130, and the web server 140 are connected over a computer network 150, e.g., the Internet.

Each client computer 110 includes conventional components of a computing device, e.g., a processor, system memory, a hard disk drive, input devices such as a mouse and a keyboard, and output devices such as a monitor. Each web server (which may be any of the web servers 120, 130, 140) includes a processor and a system memory, and manages the contents stored in its respective content storage unit using software, e.g., relational database software. Each web server is programmed to communicate with the client computers 110 and other web servers using the TCP/IP protocol. The client computers 110 are programmed to execute web browser programs and access the web pages managed by the web servers by specifying a URL for the web pages in the browser or by clicking on hyperlinks to the web pages.

In the embodiments of the present invention described below, users are respectively operating the client computers 110 that are connected to the web servers over the Internet. The web pages that are displayed to a user are transmitted from a web server to that user's client computer 110 and processed by the web browser program stored in that user's client computer 110 for display through the monitor of that user's client computer 110.

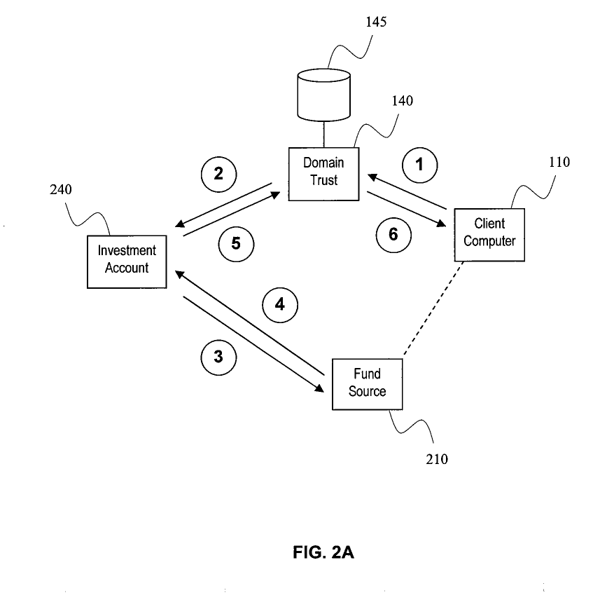

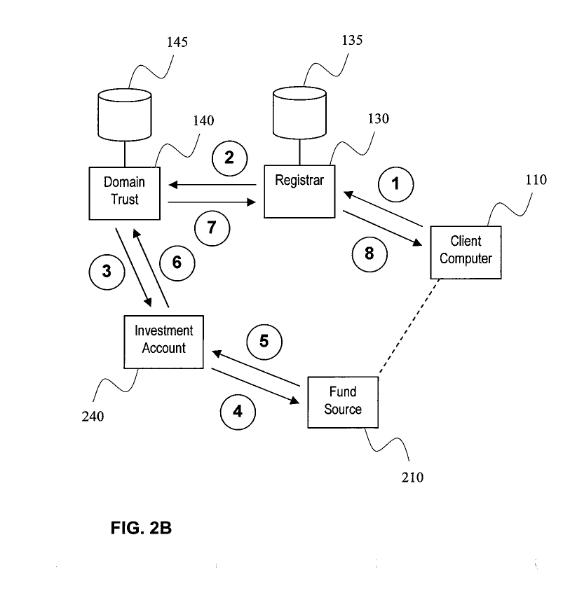

FIG. 2A illustrates the process for managing domain name registrations according to a first embodiment of the present invention. First, the user accesses the domain trust web server 140 and submits a request to register a domain name for an indefinite period. Conventionally, domain name registrations have been made for specified periods, e.g., 1 year, 2 years, 5 years, etc. In the embodiments of the present invention, the user is requesting domain name registration for an indefinite period in exchange for a lump sum payment that is to be held in trust for the registrant by the domain trust registrar. So long as the user keeps the trust funds with the domain trust registrar, the domain trust registrar automatically renews the domain name registration with ICANN for a specified period, e.g., 1 year. If the user desires to cancel the indefinite-period domain name registration, the trust funds are returned to the user and the domain name registration is allowed to expire at the end of the current term.

The domain trust registrar keeps the trust funds in an investment account so that earnings from investing the trust funds can be used to pay the renewal fees that are owed to ICANN. As an example, if the 1-year renewal fee that is owed to ICANN is $5.00 and an investment account that averages a 5% annual rate of return is used, the lump sum payment of at least $100.00 would be needed for the domain trust registrar to break even.

The lump sum payment made by the user in exchange for domain name registration for an indefinite period may be in alternative forms. As one alternative, the lump sum payment may be a refundable deposit made by the user. As another alternative, the lump sum payment may be an interest-free loan given by the user to the domain trust registrar. Whatever the form of payment, the amount that is payable to the user equals the initial payment amount reduced by any assessed penalties described below. To be clear, the accrued investment earnings belong to the domain trust registrar and are not payable to the user.

If the user cancels the domain name registration too early, the domain trust registrar may be unable to benefit sufficiently from holding the trust funds in the investment account. Therefore, a penalty is assessed for early cancellation and the amount of the penalty is dependent on how long the trust funds were held in the investment account of the domain trust registrar. As one example, any domain name registration cancelled within the first year is assessed a penalty of $10.00, between first and second years $5.00, and no penalty after the second year. When a penalty is assessed, the user is not returned the entire lump sum payment amount. Instead, the assessed penalty is deducted from the lump sum payment amount and the reduced lump sum payment is paid out to the user.

Generally, the lump sum payment obligation and the penalty for early cancellation increase as registration fees assessed by ICANN to the domain trust registrar increases. When ICANN raises the domain name registration fees, the trust funds held in the investment account may not be sufficient to make up for the ICANN increase. Therefore, the domain trust registrar sends out an additional payment request to holders of indefinite-period domain name registrations in response to such ICANN increases. Failure to make the additional payment within an allotted time will cause the cancellation of the domain name registration and, where applicable, early cancellation penalties will be assessed.

Returning to FIG. 2A, as part of the request to register a domain name for an indefinite period, the user through his or her client computer 110 provides his or her name, contact information, and electronic payment data, e.g., credit card payment information, debit card payment information, or information for conducting an electronic fund transfer from the user's bank account. The domain trust registrar 140 forwards the electronic payment data to the financial institution that manages an investment account 240 on behalf of the domain trust registrar. The financial institution, in turn, seeks an electronic funds transfer (EFT) from a fund source 210 of the user that is identified in the electronic payment data. When the EFT from the fund source 210 to the investment account 240 is made, the domain trust registrar 140 is notified and the domain trust registrar 140 sends confirmation of the domain name registration to the client computer 110 of the user.

FIG. 2B illustrates the process for managing domain name registrations according to a second embodiment of the present invention. In this embodiment, the request to register a domain name for an indefinite period is made through a third party registrar 130 instead of directly to the domain trust registrar 140. As part of the request, the user through his or her client computer 110 provides his or her name, contact information, and electronic payment data, e.g., credit card payment information, debit card payment information, or information for conducting an electronic fund transfer from the user's bank account, to the third party registrar 130. The third party registrar 130 forwards the request to the domain trust registrar, and the domain trust registrar 140 forwards the electronic payment data to the financial institution that manages an investment account 240 on behalf of the domain trust registrar. The financial institution, in turn, seeks an EFT from a fund source 210 of the user that is identified in the electronic payment data. When the EFT from the fund source 210 to the investment account 240 is made, the domain trust registrar 140 is notified and the domain trust registrar 140 sends confirmation of the domain name registration to the third party registrar 130, which forwards the confirmation to the client computer 110 of the user.

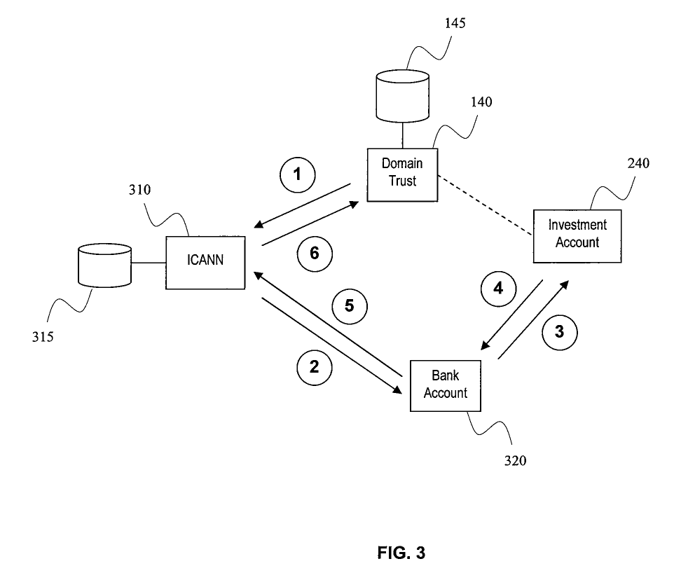

FIG. 3 illustrates the process carried out by the domain trust registrar 140 for managing the registration or renewal of a domain name with ICANN. In this illustration, the domain trust registrar 140 has an investment account 240 in which the domain trust registrar 140 has deposited trust funds (or refundable deposit or interest-free loan) received from a user who desires to register a domain name for an indefinite period or from a user who has registered a domain name for an indefinite period. First, the domain trust registrar 140 sends the domain name registration or renewal information and electronic payment data to ICANN 310. The electronic payment data identifies the investment account from which the payment to ICANN 310 will be made for the domain name registration or renewal. ICANN 310 forwards the electronic payment data to the bank that manages its bank account 320, which in turn seeks an EFT from the investment account 240 of the domain trust registrar that is identified in the electronic payment data. When the EFT from the investment account 240 to the bank account 320 is made, ICANN 310 is notified and ICANN 310 sends confirmation of the domain name registration or renewal to the domain trust registrar 140.

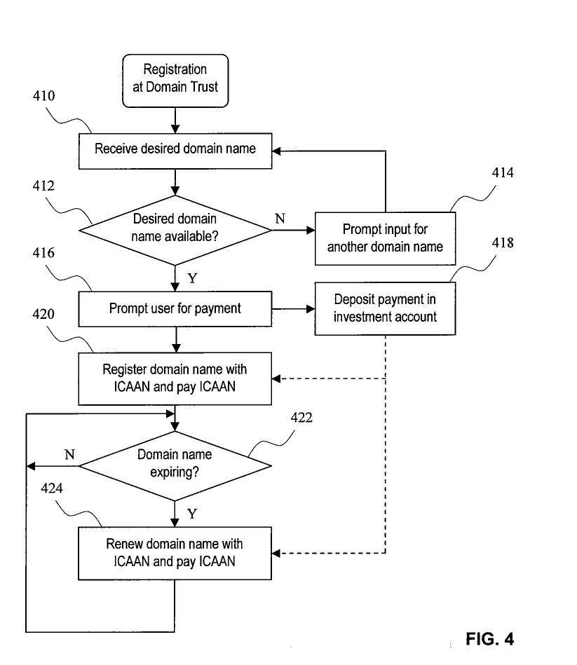

FIG. 4 is a flow diagram that illustrates the steps that are carried out by the domain trust registrar 140 in the management of domain name registrations. In step 410, the domain trust registrar 140 receives a domain name that a user desires to register for an indefinite period. In response, the domain trust registrar 140 performs a search of ICANN's database for the desired domain name. If the desired domain is not available, the user is prompted to input another domain name (steps 412 and 414). If the desired domain is available, the user is prompted to submit a lump sum payment for the indefinite-period registration (steps 412 and 416). In step 418, the lump sum payment is deposited into an investment account and held in trust for the user. The domain name is then registered with ICANN for a fixed period (e.g., 1 year) and the ICANN fee for registering the domain name for the fixed period is paid out of the funds in the investment account (step 420). Subsequently, in step 422, a check is made on a periodic basis to see if the expiration date of the domain name is a predetermined number of days away (e.g., 1 day). If it is, the domain name registration is renewed for a fixed period (e.g., 1 year) with ICANN and the ICANN fee for renewal for the fixed period is paid out of the funds in the investment account (step 424).

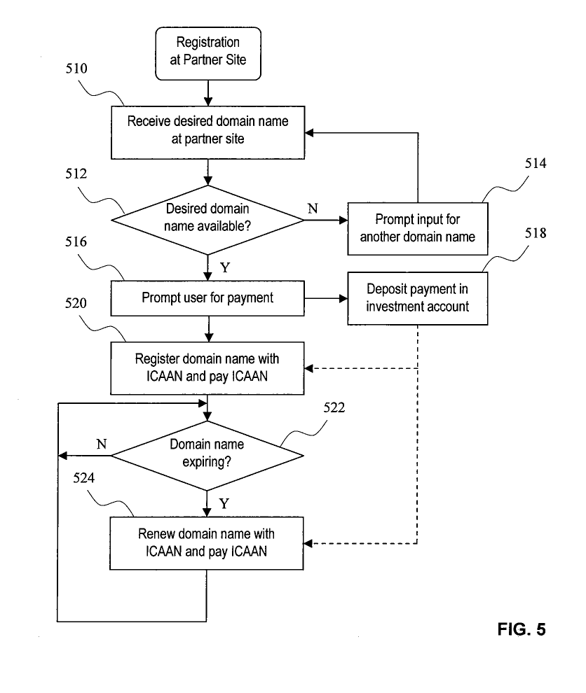

FIG. 5 is a flow diagram that illustrates the steps that are carried out by the third party registrar 130 and the domain trust registrar 140 to process a domain name registration for an indefinite period. In the example shown here, steps 510, 512, 514, and 516 are carried out by the third party registrar 130 (also referred to as “partner site”). The remaining steps are carried out by the domain trust registrar 140.

In step 510, the partner site receives a domain name that a user desires to register for an indefinite period. In response, the partner site performs a search of ICANN's database for the desired domain name. If the desired domain is not available, the user is prompted to input another domain name (steps 512 and 514). If the desired domain is available, the user is prompted to submit a lump sum payment for the indefinite-period registration (steps 512 and 516). The registration information and the payment information are then forwarded to the domain trust registrar 140 and, in step 518, the domain trust registrar 140 deposits the lump sum payment into an investment account and holds the lump sum payment in trust for the user. The domain name is then registered with ICANN for a fixed period (e.g., 1 year) and the ICANN fee for registering the domain name for the fixed period is paid out of the funds in the investment account (step 520). Subsequently, in step 522, a check is made on a periodic basis to see if the expiration date of the domain name is a predetermined number of days away (e.g., 1 day). If it is, the domain name registration is renewed for a fixed period (e.g., 1 year) with ICANN and the ICANN fee for renewal for the fixed period is paid out of the funds in the investment account (step 524).

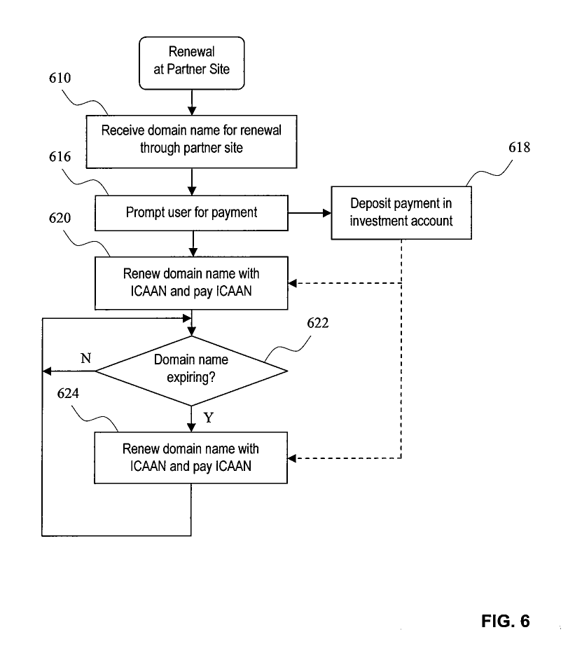

FIG. 6 is a flow diagram that illustrates the steps that are carried out by the third party registrar 130 and the domain trust registrar 140 to process a domain name renewal for an indefinite period. In the example shown here, steps 610 and 616 are carried out by the third party registrar 130 (also referred to as “partner site”). The remaining steps are carried out by the domain trust registrar 140.

In step 610, the partner site receives a request to renew a domain name for an indefinite period from the domain name registrant. In response, the user is prompted to submit a lump sum payment for the indefinite-period renewal (step 616). The domain name renewal information and the payment information are then forwarded to the domain trust registrar 140 and, in step 618, the domain trust registrar 140 deposits the lump sum payment into an investment account and holds the lump sum payment in trust for the domain name registrant. The domain name is then renewed with ICANN for a fixed period (e.g., 1 year) and the ICANN fee for renewing the domain name for the fixed period is paid out of the funds in the investment account (step 620). Subsequently, in step 622, a check is made on a periodic basis to see if the expiration date of the domain name is a predetermined number of days away (e.g., 1 day). If it is, the domain name registration is renewed for a fixed period (e.g., 1 year) with ICANN and the ICANN fee for renewal for the fixed period is paid out of the funds in the investment account (step 624).

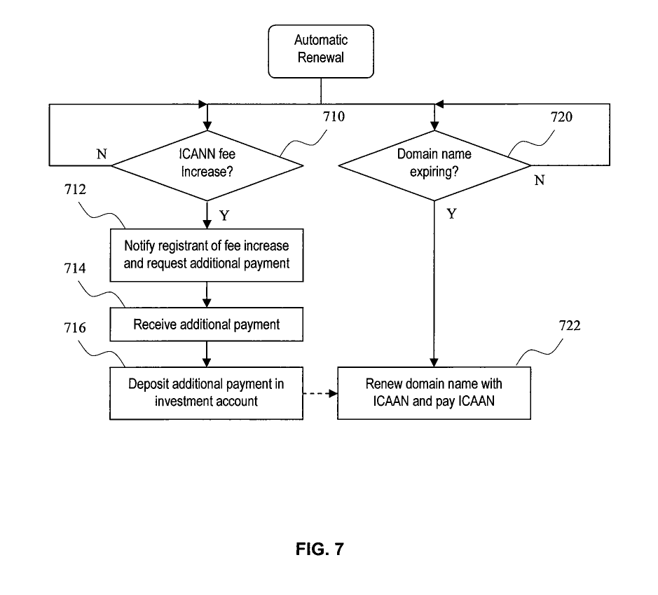

FIG. 7 is a flow diagram that illustrates the steps that are carried out by the domain trust registrar 140 when automatically renewing a domain name registration. In step 710, a check is made to see if the fee that ICANN charges domain name registrars for registering domain names has increased. If it has, steps 712, 714, and 716 are carried out for each of the domain name registrants. In step 712, the domain name registrant is notified of the ICANN fee increase and is prompted for additional payment. The additional payment is received in step 714 and deposited in the investment account that holds the original lump sum payment in step 716. It is noted that, if the domain name registrant does not submit the additional payment within an allotted time, the domain name is not renewed at the end of the then current term and, where applicable, the domain name registrant is assessed an early cancellation penalty.

Steps 720 and 722 are carried out independently of steps 710, 712, 714, and 716. In step 720, a check is made on a periodic basis to see if the expiration date of the domain name is a predetermined number of days away (e.g., 1 day). If it is, the domain name registration is renewed for a fixed period (e.g., 1 year) with ICANN and the ICANN fee for renewal for the fixed period is paid out of the funds in the investment account (step 722).

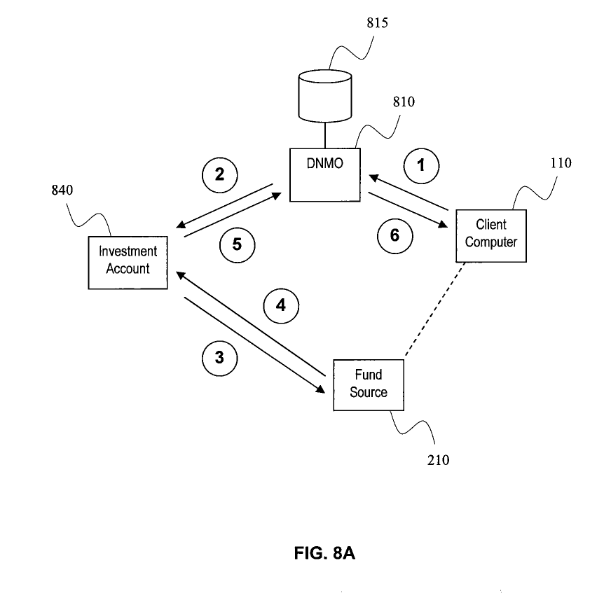

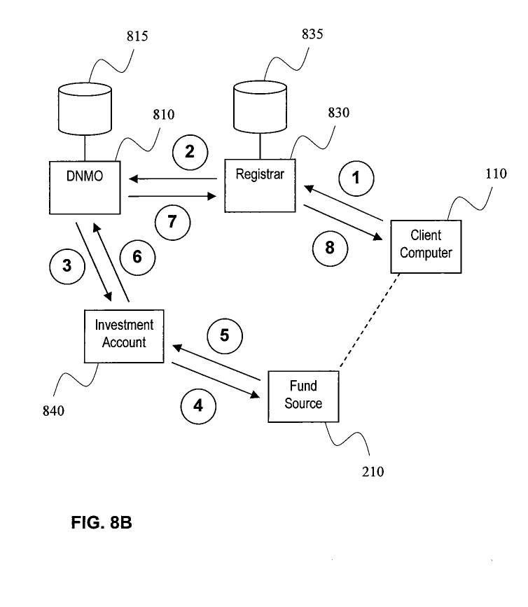

FIGS. 8A and 8B illustrate the process for managing domain name registrations according to third and fourth embodiments of the present invention. In these embodiments, ICANN or generally an organization that has been entrusted with the task of managing the assignment of domain names and IP addresses (hereinafter referred to as the “domain name management organization” or “DNMO”), offers domain name registrants the option of registering or renewing a domain name for an indefinite period in exchange for a lump sum payment. In response to a user's request to register or renew a domain name for an indefinite period and the lump sum payment, the DNMO registers the domain name in the user's name and keeps the status of the domain name registration active so long as the user keeps the lump sum payment with the DNMO. If the user cancels the indefinite-period domain name registration, the lump sum payment is returned to the user minus any applicable penalties for early cancellation, and the domain name registration is cancelled.

FIG. 8A illustrates the process for managing domain name registrations in which the user accesses the DNMO directly. First, the user accesses the DNMO 810 and submits a request to register a domain name for an indefinite period. As part of this request, the user through his or her client computer 110 provides his or her name, contact information, and electronic payment data, e.g., credit card payment information, debit card payment information, or information for conducting an electronic fund transfer from the user's bank account. The DNMO 810 stores the user's contact information in its content storage unit 815 and forwards the electronic payment data to the financial institution that manages an investment account 840 on behalf of the DNMO 810. The financial institution, in turn, seeks an EFT from a fund source 210 of the user that is identified in the electronic payment data. When the EFT from the fund source 210 to the investment account 840 is made, the DNMO 810 is notified and sends confirmation of the domain name registration to the client computer 110 of the user.

In the case where the user accesses the DNMO 810 and submits a request to renew a domain name for an indefinite period, as part of this request, the user submits any changes to the domain name registration information maintained by DNMO 810 along with the electronic payment data. The DNMO 810 updates the user's information in its content storage unit 815 and forwards the electronic payment data to the financial institution that manages an investment account 840 on behalf of the DNMO 810. The financial institution, in turn, seeks an EFT from a fund source 210 of the user that is identified in the electronic payment data. When the EFT from the fund source 210 to the investment account 840 is made, the DNMO 810 is notified and sends confirmation of the domain name renewal to the client computer 110 of the user.

FIG. 8B illustrates the process for managing domain name registrations in which the user accesses the DNMO through a registrar approved by the DNMO. In this embodiment, the request to register a domain name for an indefinite period is made through a DNMO-approved registrar 830 having an associated content storage unit 835 instead of directly to the DNMO 810. As part of the request, the user through his or her client computer 110 provides his or her name, contact information, and electronic payment data, e.g., credit card payment information, debit card payment information, or information for conducting an electronic fund transfer from the user's bank account, to the DNMO-approved registrar 830. The DNMO-approved registrar 830 forwards the request to the DNMO 810. The DNMO 810 stores the user's contact information in its content storage unit 815 and forwards the electronic payment data to the financial institution that manages an investment account 840 on behalf of the DNMO 810. The financial institution, in turn, seeks an EFT from a fund source 210 of the user that is identified in the electronic payment data. When the EFT from the fund source 210 to the investment account 240 is made, the DNMO 810 is notified and the DNMO 810 sends confirmation of the domain name registration to the DNMO-approved registrar 830, which forwards the confirmation to the client computer 110 of the user.

In the case where the user accesses the DNMO-approved registrar 830 and submits a request to renew a domain name for an indefinite period, as part of this request, the user submits any changes to the domain name registration information maintained by the DNMO-approved registrar 830 through DNMO 810 along with the electronic payment data. The DNMO-approved registrar 830 forwards this request to the DNMO 810. The DNMO 810 updates the user's information in its content storage unit 815 and forwards the electronic payment data to the financial institution that manages an investment account 840 on behalf of the DNMO 810. The financial institution, in turn, seeks an EFT from a fund source 210 of the user that is identified in the electronic payment data. When the EFT from the fund source 210 to the investment account 240 is made, the DNMO 810 is notified and the DNMO 810 sends confirmation of the domain name registration to the DNMO-approved registrar 830, which forwards the confirmation to the client computer 110 of the user.

According to the embodiments of the present invention, a user who registers a domain name for an indefinite period is no longer required to actively monitor or manage the registered domain name. By contrast, under the current system, a user is required to be responsive to any correspondence from ICANN or the domain name registrar. A failure to respond in a timely manner to such correspondence runs the risk of having the domain name cancelled. With the embodiments of the present invention, full domain name management is provided by the domain trust registrar 140 in the case of the first and second embodiments and by the DNMO 810 in the case of the third and fourth embodiments. All the user is required to do is to make the one-time lump sum payment and keep the lump sum payment with the domain trust registrar 140 or DNMO 810. Also, with embodiments of the present invention, renewal of the domain names is handled by the domain trust registrar 140 in the case of the first and second embodiments and is not necessary in the case of the third and fourth embodiments. Therefore, renewal notices need not be sent out to the user.

The advantages discussed above increases in importance when a user manages a large number of domain name registrations. For example, a user that manages hundreds of domain names for a large corporation, most of which will be registered in the corporation's name on an ongoing basis, would find to be of great benefit the ability to register these domain names for an indefinite period and not actively monitor or manage their renewals and/or respond to correspondence from ICANN or the domain name registrar.

While the foregoing is directed to embodiments of the present invention, other and further embodiments of the invention may be devised without departing from the basic scope thereof, and the scope thereof is determined by the claims that follow.

We claim:

1. A process for managing domain name registrations, comprising:
receiving a request to register a domain name for an indefinite period;
registering the domain name for a specified period; and
prior to expiration of the domain name registration, renewing the domain name registration.

2. The process according to claim 1, further comprising:
receiving payment data along with the request; and
initiating an electronic funds transfer into an investment account using the payment data.

3. The process according to claim 2, wherein the funds transferred into the investment account comprise money held in trust for a registrant of the domain name.

4. The process according to claim 3, further comprising:
receiving a request to cancel the domain name registration; and
paying the registrant of the domain name the money held in trust less an offset that is zero or more.

5. The process according to claim 4, wherein the amount of offset is dependent on the duration of the domain name registration.

6. The process according to claim 2, wherein the funds transferred into the investment account comprise a refundable deposit from a registrant of the domain name.

7. The process according to claim 6, further comprising:
receiving a request to cancel the domain name registration; and
paying the registrant of the domain name the refundable deposit less an offset that is zero or more.

8. The process according to claim 7, wherein the amount of offset is dependent on the duration of the domain name registration.

9. The process according to claim 2, wherein the funds transferred into the investment account comprise an interest-free loan from a registrant of the domain name.

10. The process according to claim 9, further comprising:
receiving a request to cancel the domain name registration; and
paying the registrant of the domain name the loan amount less an offset that is zero or more.

11. The process according to claim 10, wherein the amount of offset is dependent on the duration of the domain name registration.

12. The process according to claim 1, wherein registering the domain name comprises submitting domain name registration data and payment data for the domain name registration to ICANN.

13. The process according to claim 12, wherein renewing the domain name registration comprises submitting domain name registration renewal data and payment data for the domain name registration renewal to ICANN.

14. The process according to claim 1, wherein the specified period is one year.

15. The process according to claim 14, wherein the period for renewal is one year.

16. A process for managing domain name registrations, comprising:
receiving a request to renew a domain name registration for an indefinite period;
renewing the domain name registration for a first specified period; and
prior to expiration of the domain name registration, renewing the domain name registration for a second specified period.

17. The process according to claim 16, further comprising:
receiving payment data along with the request; and
initiating an electronic funds transfer into an investment account using the payment data.

18. The process according to claim 17, wherein renewing the domain name registration comprises submitting domain name registration renewal data and payment data for the domain name registration renewal to ICANN.

19. The process according to claim 16, wherein the first specified period is one year.

20. The process according to claim 19, wherein the second specified period is one year.

21. A computer system for managing domain name registrations, comprising:
a domain name database storing multiple datasets, each dataset identifying a domain name, a registrant, an expiration date for the domain name registration, and amount of money that is payable to the registrant; and
a processor programmed to submit domain name renewal registration data to ICANN prior to the expiration date for the domain name registration, and to initiate a payment to the registrant of the amount of money that is payable to the registrant in response to a request to cancel the domain name registration.

22. The computer system according to claim 21, wherein the amount of money payable to the registrant comprises money held in an investment account in trust for the registrant.

23. The computer system according to claim 21, wherein the amount of money payable to the registrant comprises a refundable deposit made by the registrant.

24. The computer system according to claim 21, wherein the amount of money payable to the registrant comprises an interest-free loan from the registrant.

25. A process for renewing a domain name registration continuously for an indefinite period using electronic funds of a domain name registrant that have been deposited into an investment account, comprising:
investing the electronic funds in the investment account; and
renewing the domain name registration for a specified period on a periodic basis using the electronic funds in the investment account.

26. The process according to claim 25, wherein the specified period is one year.

27. The process according to claim 25, wherein renewing the domain name registration comprises submitting domain name registration renewal data and payment data for the domain name registration renewal to ICANN.

28. The process according to claim 27, further comprising the step of depositing additional electronic funds of the domain name registrant into the investment account after the step of renewing has been carried out at least one time.

29. The process according to claim 28, wherein the cost of renewing the domain name registration for the specified period prior to the step of depositing additional electronic funds is less than the cost of renewing the domain name registration for the specified period after the step of depositing additional electronic funds.

30. The process according to claim 29, wherein the increased cost is attributable to a cost increase by ICANN.

31. A process for managing domain name registrations, comprising:
receiving a request to register a domain name for an indefinite period;
receiving payment data along with the request;
initiating an electronic funds transfer into an investment account using the payment data; and
registering the domain name and keeping the domain name registration active until a request to cancel the domain name registration is received.

32. The process according to claim 31, further comprising:
receiving a request to cancel the domain name registration; and
paying the registrant of the domain name an amount of money equal to the payment received with the indefinite-period registration request less an offset that is zero or more.

33. The process according to claim 32, wherein the amount of offset is dependent on the duration of the domain name registration.

34. A process for managing domain name registrations, comprising:
receiving a request to renew a domain name registration for an indefinite period;
receiving payment data along with the request;
initiating an electronic funds transfer into an investment account using the payment data; and
renewing the domain name registration and keeping the domain name registration active until a request to cancel the domain name registration is received.

35. The process according to claim 34, further comprising:
receiving a request to cancel the domain name registration; and
paying the registrant of the domain name an amount of money equal to the payment received with the indefinite-period renewal request less an offset that is zero or more.

36. The process according to claim 35, wherein the amount of offset is dependent on the duration of the indefinite-period domain name registration renewal.
